(19) United States
(12) Patent Application Publication
(10) Pub. No.: US 2012/0164492 A1
(43) Pub. Date: Jun. 28, 2012

(54) ACCUMULATOR WITH EXTENDED DURABILITY

(75) Inventors: Walter Lachenmeier, Sankt Augustin (DE); Andreas Gutsch, Luedinghausen (DE); Tim Schaefer, Niedersachswerfen (DE)

(73) Assignee: LI-TEC BATTERY GMBH, Kamenz (DE)

(21) Appl. No.: 13/263,154

(22) PCT Filed: Mar. 30, 2010
(86) PCT No.: PCT/EP10/02030

§ 371 Date: Mar. 16, 2012

(30) Foreign Application Priority Data
Apr. 8, 2009 (DE) 10 2009 016 867.2

(51) Int. Cl. H01M 10/42; H01M 10/48; B23P 19/04; H01M 10/02; H01M 2/02; H01M 2/10; H01M 10/50; H01M 10/04

(52) U.S. Cl. 429/50; 429/120; 429/90; 429/81; 429/100; 29/428

(57) ABSTRACT

The present invention relates to an accumulator with extended durability. The invention is described in relation to a lithium-ion-accumulator for supplying a motor vehicle drive. However, it should be noted that the invention will also be applicable for batteries without lithium and/or independent from motor vehicles.

Priority application DE 10 2009 016 867.2 is fully incorporated by reference into the present application.

The present invention relates to a rechargeable battery having an extended service life. The invention is described with respect to a lithium-ion rechargeable battery for supplying a motor vehicle drive. However, it should be pointed out that the invention can also be applied to batteries without lithium and/or independently of motor vehicles.

Rechargeable batteries comprising galvanic cells for storing electric energy are known from the prior art. The electric energy supplied to a rechargeable battery is converted into chemical energy and stored. This conversion is subject to loss. Moreover, irreversible chemical reactions take place during this conversion and cause aging of the rechargeable battery. As the temperature rises inside a galvanic cell of a rechargeable battery, not only is the conversion of the energy faster, but the aging process is also expedited. In particular during acceleration of an electrically driven motor vehicle, high electric currents are withdrawn from the rechargeable battery over short periods. These high electric currents also occur if the deceleration of a motor vehicle is supported by electric devices and the energy gained is supplied to the rechargeable battery.

The disadvantage is that these brief high currents cause the rechargeable battery to age prematurely.

It is therefore the object of the present invention to increase the service lives of rechargeable batteries operated in this way. This is achieved according to the invention by the subject matter of the independent claims. Advantageous embodiments and refinements are the subject matter of the dependent claims.

A device according to the invention for storing electric energy comprises at least one galvanic cell. This cell is surrounded at least partially by a cell jacket. The device according to the invention is characterized in that it comprises at least one heat conducting unit, which is operatively connected to the galvanic cell. This heat conducting unit is suited to supply heat output to the galvanic cell and/or dissipate it from the galvanic cell.

The device according to the invention preferably comprises at least one cell holder. Together with a wall, this holder encloses an interior space at least partially. This space is suited to receive the at least one galvanic cell. To this end, the cell jacket is thermally operatively connected to this wall at least in some regions. The device moreover comprises at least one first measuring unit. This unit is suited to capture a temperature at a predefined position of the galvanic cell. The device also comprises a control unit. This unit is at least suited to evaluate the signals of the existing first measuring units and/or to control existing heat conducting units. To this end, heat conducting means are disposed between this cell jacket of the wall of the cell holder and/or a further existing cell jacket.

The device for storing electric energy having at least one galvanic cell is a primary or secondary battery, which provides electric energy by the conversion from chemical energy. If the device is designed as a secondary battery, it is also suited to receive electric energy, convert it into chemical energy and store it as chemical energy. In addition to at least one galvanic cell, the device comprises various other units for an organized operation and supplies a motor vehicle drive.

The device according to the invention comprises at least one galvanic cell, however preferably it comprises a plurality of cells in a parallel and/or series connection so as to increase the voltage and/or the charge contained. Preferably, for example, four galvanic cells at a time are connected in series to form a group so as to achieve a predefined operating voltage. A plurality of such groups are preferably connected in parallel and store a larger charge.

Such a galvanic cell is surrounded by a cell jacket. This cell jacket protects the galvanic cell and the chemicals thereof from harmful outside influences, for example from the atmosphere. This cell jacket is preferably formed by a gas-tight and electrically insulating solid matter or layer composite, for example a welded film. The cell jacket preferably has thin walls and is designed to conduct heat. This cell jacket preferably encloses the galvanic cell as tightly as possible. However, it is not necessary for this galvanic cell to be surrounded entirely by the cell jacket. The cell jacket can also surround only parts of this galvanic cell.

A heat conducting unit exhibits increased thermal conductivity and is used to feed thermal energy to a galvanic cell that is operatively connected. This is advantageous in particular at low ambient temperatures. In addition, a heat conducting unit preferably dissipates thermal energy from a galvanic cell that is operatively connected. This preferably takes place when high electric current is fed to or withdrawn from the galvanic cell. These high currents cause the galvanic cell to heat up, however a temperature of a cell that is too high shortens the service life of the same. Heat is preferably withdrawn from the galvanic cell by means of an operatively connected heat conducting unit, resulting in gentler use of the cell. These high currents occur primarily during acceleration phases of the motor vehicle, or during deceleration phases of the same, for example, when the deceleration takes place via an electric motor acting as a generator. The term ‘operatively connected’ shall be understood to mean that the galvanic cell has at least thermal contact with the heat conducting unit.

The device comprises a cell holder. This holder comprises an interior space that is geometrically adapted to the galvanic cells that are received and a wall that surrounds this interior space at least partially. In addition to the galvanic cells, this cell holder preferably accommodates further units, for example measuring units, control units and other units or components required for operating the rechargeable battery. The wall also enables a connection and attachment to the motor vehicle. For economic considerations, the wall is preferably designed to be thin. The wall preferably tightly encloses the galvanic cells received in a heat-conducting manner, so that the cell jackets of the galvanic cells exchange large amounts of heat output with this wall. These galvanic cells preferably give off heat to the wall or take up heat from the same.

A heat conducting means preferably exhibits increased thermal conductivity and is designed as the thinnest layer possible. Suitable products include pastes, which are applied, for example, by means of a brush or a roller; films, which are placed or glued on; or thin mats cut to size. These heat conducting means are provided to avoid air inclusions, enlarge the heat-transmitting surface areas, and thus increase the heat output that is transmitted. These heat conducting means improve the cooling or heating of the galvanic cells that are received by the interior space. Heat conducting means are advantageously applied to such surface areas that are used to transfer heat from one unit to another. Still more preferably, heat conducting means are disposed between individual galvanic cells and/or between galvanic cells and, for example, the wall of the cell holder.

The device comprises at least first measuring units that detect the temperature at a predefined site of a galvanic cell. To this end, a plurality of measuring means for capturing temperatures at various positions of a galvanic cell can also be connected to a measuring unit. This measuring unit is suited to record the signals of the measuring means at any time. For practical considerations and so as to reduce the data volume, the capturing is preferably only carried out from time to time. This is also dependent on the thermal capacities and thermal transmission coefficients that are involved. A first measuring unit forwards signals to a control unit that is also present. This control unit preferably triggers the capturing of temperatures by a first measuring unit as a function of the operating conditions.

The device comprises a control unit. This control unit controls at least the first measuring units that are present and evaluates the signals thereof. This is done based on predefined computing rules. These rules take different characteristic curves of the individual measuring means into account. The control unit is also suited to control heat conducting units that are present. Depending on the operational state of a galvanic cell, individual or several heat conducting units are switched. The functions of the control unit of the device according to the invention can also be assumed by another controller or battery management system.

Advantageously, a device according to the invention is operated so that the control unit thereof initially captures the temperature at a predefined site of a galvanic cell. Depending on this temperature, the control unit switches a heat conducting unit on or off. The control unit preferably switches delivery units for fluids on or off. This remedies premature aging of a device for storing electric energy and extends the service life thereof.

The control unit is advantageously connected to a memory unit. This unit is used to save captured data and evaluated measurement values and/or computing rules. Together with a measurement value, or an evaluated measurement value, an additional value is saved that is representative of the time of the measurement. Preferably specifications or target values for a measured parameter are saved in this memory unit, for example the temperature of a cell.

In a particularly advantageous embodiment, the device comprises a control unit, an associated memory unit and at least one first measuring unit. The control unit is suited to form a difference between a measurement value or signal of this first measuring unit and a predefined value. Depending on this temperature difference, the control unit switches a heat conducting unit on or off. The control unit preferably switches delivery units for fluids on or off. This remedies premature aging of a device for storing electric energy and extends the service life thereof.

The device according to the invention is advantageously also equipped with at least one second measuring unit. This unit is suited to capture the charging or discharging current into or out of an associated galvanic cell and transmit it to the control unit. The number of the two measuring units corresponds to the number of galvanic cells, preferably it is even lower. The current intensity is captured continuously, preferably in accordance with the specification of the control unit as a function of the operating conditions.

In a particularly advantageous embodiment, the device comprises a control unit, an associated memory unit, at least one first measuring unit, and at least one second measuring unit. The control unit is suited to form a difference between a measurement value or signal of the first measuring unit and a predefined value. Moreover, this control unit is suited to link the measurement values of a first measuring unit to a signal of a second measuring unit using a saved computing rule. If the measured current intensities and the detected temperatures, or temperature differences, are suitably linked, the control unit preferably estimates the future temporal development of the cell temperature using saved computing rules. In anticipation of a future temperature change of a galvanic cell, the control unit preferably switches heat conducting units and/or delivery units for a fluid on or off. At a high discharging current, the control unit, for example, switches a delivery unit for a fluid and/or a heat conducting unit on as early as an acceleration phase of the motor vehicle, even before a notable increase in a cell temperature.

Preferably, one or more galvanic cells have a prismatic base surface area, still more preferably a rectangular base surface area. Such cuboid galvanic cells can be brought in thermal contact with each other particularly well and can be accommodated in the interior space. A galvanic cell preferably also comprises a substantially plate-shaped current conductor as the heat conducting unit. This current conductor conducts the electric current out of the galvanic cell or into the same. The current conductor is preferably metallic and has high thermal conductivity. Because of this high thermal conductivity, the temperature gradients that occur within a current conductor are low and high heat flows are conducted into or out of the galvanic cell. A first region of the current conductor is disposed inside a galvanic cell. A second region of the current conductor extends out of the galvanic cell. In order to improve the heat dissipation or heat introduction, this second region is at least as wide as the first region of the current conductor inside the galvanic cell. The current conductor preferably has a plate-shaped design and is defined by the plate thickness, width and height/length. The height is measured along an edge of the plate-shaped current conductor that extends over the first region and second region out of the galvanic cell. For practical considerations, the second region of a current conductor is cooled or heated by thermal conduction to a heat sink or convection. This heat sink is thermally connected to the current conductor, preferably using a heat conducting means. Preferably a first fluid flows at least partially around the heat sink or the current conductor. Depending on the temperature of the first fluid flowing around and depending on the temperature of the current conductor or heat sink, heat is supplied to or withdrawn from the galvanic cell. The heat sink preferably comprises copper, and still more preferably copper and aluminum. Still more preferably, a copper-containing region of the heat sink is in thermal contact with the current conductor, while the first fluid flows against an aluminum-containing region of the heat sink.

Metallic particles, for example, can be added to a synthetic material or resin in order to increase the thermal and/or electric conductivity. Depending on the function of the adjacent components, a heat conducting means is preferably electrically insulating. A heat conducting means that is electrically insulating and heat conducting at the same time and has a predefined shape, referred to as a “heat pad”, comprises, for example, mica, various types of ceramics (for example Al₂O₃, BeO), silicone rubber, diamond, carbon nanotubes, polyimide or another synthetic material. After adding metallic particles, various adhesives are also suitable as heat conducting means. In addition, a heat conducting adhesive bonds the adjacent components.

In addition to the aforementioned current conductors, a galvanic cell preferably comprises active heat conducting units. These preferably comprise at least one fluid duct and a second fluid contained therein. This second fluid flows through the fluid duct, or is retained in the fluid duct, provided the fluid duct is a closed space. Depending on the prevailing temperatures and the chemical composition of the second fluid, the fluid is subject to phase transitions, preferably from liquid to gaseous or vice versa. In one embodiment, this second fluid is first supplied to the first fluid duct at a predefined temperature and is removed again after heat delivery or absorption. The fluid duct comprises a third region within the cell or in thermal contact with this cell. The fluid duct preferably also comprises a fourth region outside of the cell. A third fluid preferably flows at least partially around this fourth region and/or the region is connected to a heat sink in a heat-conducting manner. This third fluid preferably also flows against the heat sink.

The device preferably comprises a container. This container is connected to the cell receptacle, for example. The container comprises at least one closing element and is filled with a third substance. This closing element is suited to be opened by the control unit. Subsequently, the third substance exits the container. To this end, the third substance preferably exits in the direction of at least one galvanic cell, for example through a duct that is provided. After a predefined time, or after a predefined quantity of the third substance has exited, the control unit closes the closing element. At the latest upon impingement on the galvanic cell, the substance undergoes a phase transition during which thermal energy is taken up or given off. The container is preferably connected to a plurality of ducts directed toward various galvanic cells. When using individual ducts, only individual galvanic cells are supplied with this third substance if necessary. Cells supplied in this manner are heated or cooled by the phase transition energy. A closing element is preferably additionally equipped with a temperature-sensitive switch, for example a bimetallic switch. Such a design advantageously allows for thermal energy to be given off or taken up even if the controller, heat conducting unit and/or delivery unit for a fluid are not ready for operation or have failed.

The wall of the cell holder advantageously comprises at least one curable first substance and highly heat conductive embedded particles. Advantageously, the wall is designed as a thin wall so as to reduce the thermal resistance and to be tightly seated against the galvanic cells. The wall particularly advantageously encloses the galvanic cells that are received at least partially, so that good heat transfer exists between the galvanic cells received and the wall. This wall preferably comprises at least one second fluid duct. A fourth fluid flows through this second fluid duct, the fluid being supplied at a predefined temperature. After it leaves the second fluid duct, the fourth fluid is conditioned by a vehicle-side or an independent cooler or heater, for example. This wall preferably comprises a prepared connecting surface area for the thermal contact with an evaporator or cooler. This exchanges thermal energy, for example, with the ambient air or with the air conditioner of the motor vehicle.

The wall advantageously comprises a second substance at least in some areas. This second substance is suited to undergo phase transitions during the operation of the rechargeable battery and/or at a predefined temperature. The second substance is contained, for example, in a predefined space in or on the wall of the cell holder. This wall comprises the second substance at least in some areas, or in most areas, for example. A phase transition of this second substance takes place at a substance-specific temperature and thus also influences the temperature of a galvanic cell. Such a design of the wall of the cell holder advantageously allows for thermal energy to be given off or taken up even if the controller, heat conducting unit and/or delivery unit for a fluid are not ready for operation or have failed.

The use of the invention in secondary batteries or rechargeable batteries, or primary batteries, having a high power density or energy density is associated with advantages. At operating conditions marked by brief high currents, such rechargeable batteries exhibit significant temperature changes, notably temperature increases. Significant and recurring temperature increases cause the rechargeable battery to age more quickly. This applies in particular to nickel-metal hydride rechargeable batteries or lithium-ion rechargeable batteries. A design of such rechargeable batteries in accordance with the invention increases the service life of the same through preventive temperature control measures, which is to say at the planned temporal temperature curve of the individual galvanic cells.

The cell holder for a device according to the invention is advantageously produced using a mold and at least one curable first substance. To this end, the galvanic cells to be received are arranged in this mold by being positioned toward one another. Any gaps that may exist between these galvanic cells are filled with heat conducting means, preferably thermally conductive films. Subsequently, these cells are pressed against one another so as to achieve a good thermal connection between these galvanic cells. Next, cavities provided within the mold are potted with this curable first substance. Thereafter, the curable first substance is given the opportunity to cure.

Within the spirit of the invention, an electrolyte shall be understood as a substance that is present in at least partially ionized form and is provided to conduct electric current when a voltage is applied under the influence of the resulting electric field, wherein the electric conductivity or the charge carrier transport is effected by the directed movement of the ions in the electric field.

Within the spirit of the invention, an electrode stack shall be understood as a unit of a galvanic cell that is used to store chemical energy and to deliver electric energy. To this end, the electrode stack comprises a plurality of plate-shaped elements, at least two electrodes, the anode and cathode, and a separator, which receives the electrolyte at least partially. Preferably at least one anode, a separator and a cathode are placed or stacked on top of one another, wherein the separator is disposed at least partially between the anode and cathode. This sequence of the anode, separator and cathode can be repeated with arbitrary frequency within the electrode stack. The plate-shaped elements are preferably wound to form an electrode coil. Hereinafter, the term “electrode stack” is also used for electrode coils. Prior to the delivery of electric energy, stored chemical energy is converted into electric energy. During charging, the electric energy that is fed to the electrode stack, or to the galvanic cell, is converted into chemical energy and stored. The electrode stack preferably comprises a plurality of electrode pairs and separators. Still more preferably, a plurality of electrodes are connected to one another, in particular electrically.

Within the spirit of the invention, a contact shall be understood as an array of at least one first body and at least one second body, which is designed such that thermal energy can be transmitted from the at least one first body to the at least one second body and/or vice versa.

The device according to the invention preferably comprises at least one heat conducting unit, which is associated with the at least one galvanic cell and which is provided, at least regionally, for the contact with the at least one galvanic cell, and in particular at least regionally for the contact with the electrode stack of the at least one galvanic cell. This contact is preferably designed so that thermal energy can be supplied directly to, and/or withdrawn from, the at least one galvanic cell and/or in particular the electrode stack of the at least one galvanic cell.

The at least one heat conducting unit preferably comprises at least one fluid duct, which is notably provided for a fluid to flow through. This fluid duct preferably extends at least over a portion of the at least one heat conducting unit in the transverse direction and/or longitudinal direction. Advantageously, higher thermal output is transported through this fluid duct within the at least one heat conducting unit than in a heat conducting unit having an identical geometry but no fluid duct.

The fluid preferably undergoes at least one phase transition, wherein the temperature of the at least one phase transition of this fluid is adapted to the operating temperature of the at least one galvanic cell. A preferred fluid is one which in the operating temperature range of the at least one galvanic cell undergoes, at least partially, a phase transition from a liquid to a gaseous state. The thermal energy required for the phase transition of the fluid into a gaseous state is advantageously withdrawn from the at least one connected galvanic cell and/or in particular the connected electrode stack of the at least one galvanic cell, wherein the at least one galvanic cell and/or the electrode stack of the at least one galvanic cell are being cooled.

The at least one heat conducting unit preferably comprises at least one first region and a second region, with this second region being disposed outside of the cell jacket. In a first embodiment of the at least one galvanic cell, the fluid is preferably evaporated in the at least one first region, wherein the thermal energy required for evaporating this fluid is withdrawn in particular from the at least one galvanic cell and/or the electrode stack of the at least one galvanic cell, and wherein the evaporated fluid transports the thermal energy that is taken up from the at least one first region within the at least one galvanic cell into the at least one second region outside of the at least one galvanic cell. The gaseous fluid is preferably condensed dissipating at least a portion of the thermal energy that is taken up in the at least one second region. This advantageously prevents overheating of the at least one galvanic cell and/or of the electrode stack of the at least one galvanic cell during operation. In a second embodiment of the at least one galvanic cell, the fluid is preferably also evaporated in the at least one second region, wherein the thermal energy required for evaporating this fluid is withdrawn in particular from the surroundings of the at least one second region, and wherein the evaporated fluid transports the thermal energy that is taken up from the at least one second region outside of the at least one galvanic cell into the at least one first region within the at least one galvanic cell. The gaseous fluid is preferably condensed dissipating at least a portion of the thermal energy that is taken up in the at least one first region. In this way, if necessary, the at least one galvanic cell and/or the electrode stack of the at least one galvanic cell is advantageously heated to a temperature that is preferred for the operation of the at least one galvanic cell.

The electrode stack of the at least one galvanic cell preferably comprises at least one current conductor, wherein the at least one heat conducting unit is provided for the contact with the at least one current conductor. In particular a high charging and/or discharging current of the at least one galvanic cell results in considerable heating of the at least one current conductor. The at least one heat conducting unit preferably also withdraws thermal energy from the at least one current conductor and thereby lowers the thermal load of this at least one current conductor.

The at least one first region of the heat conducting unit is preferably provided for the heat exchange with the at least one galvanic cell and/or with the electrode stack of the at least one galvanic cell, and the at least one second region of the heat conducting unit is preferably provided for at least one second fluid to flow against or through it. In this embodiment of the at least one galvanic cell, the at least one galvanic cell and/or the electrode stack of the at least one galvanic cell is advantageously heated or cooled, depending on the temperatures prevailing in the surroundings of the at least one first or the at least one second region of the heat conducting unit.

Within the spirit of the invention, a heat exchanger unit shall be understood as a unit that is provided to transfer thermal energy from at least one first fluid flow to at least one second fluid flow. An indirect transfer of thermal energy of the heat exchanger unit is preferred, which is characterized in that the fluid flows are spatially separated from one another by at least one heat conducting solid body.

The at least one second region of the heat conducting unit is preferably provided at least in some regions for the contact with at least one heat exchanger unit.

The at least one heat conducting unit is preferably designed integral with the at least one current conductor, wherein the at least one heat conducting unit extends at least partially over the at least one current conductor.

The at least one fluid duct is preferably closed. It is further preferred for the at least one closed fluid duct to be designed as a heat pipe.

Within the spirit of the invention, a heat pipe shall be understood as a unit which is also provided for conducting heat, wherein the thermal energy to be transported can be transferred very efficiently from at least one first location to at least one second location by means of the heat pipe. When designed appropriately, the heat flow that the heat pipe can conduct is greater by a factor of up to 3 than a component having identical geometrical dimensions that is made of solid copper. The heat pipe takes advantage of the physical effect of higher heat output being converted during the evaporation and condensation of a liquid than during heat conduction in a solid body. The working medium evaporates in at least one first location of the heat pipe, wherein the temperature at this at least one first location is above the corresponding phase transition temperature of the working medium of the heat pipe. The vaporous working medium is condensed at this at least one second location of the heat pipe, wherein the temperature at this at least one second location is below the corresponding phase transition temperature of the working medium. The flow direction of the vaporous working medium in particular corresponds substantially to the direction of the temperature gradient within the heat pipe. A heat pipe preferably comprises an evaporation zone, a preferably adiabatic transport zone, a condensation zone, and a gas storage, which are preferably consecutively connected to one another and preferably designed integrally. Given the weight of the condensate, the condensate preferably flows from the condensation zone into the evaporation zone. It is further preferred for the heat pipe to comprise a capillary section at least in some regions, which is formed in at least one interior of the evaporation zone in which the working medium moves and which is also provided to deliver the condensate in a direction that is different from the weight force thereof. Preferably a negative pressure exists inside the heat pipe, so that the working medium already evaporates at low temperatures. The heat pipe also preferably operates with water as the working medium, wherein with an appropriate design, heat conduction is possible already at temperatures around 3° C. at an internal pressure of 1 Pa.

During the work cycles, which is to say during the succession of charging and discharging of the galvanic cell, this galvanic cell is heated, wherein this heating increases the greater the charging and discharging currents. During the operation of galvanic cells, the electrolyte temperature must not exceed the maximum permitted temperature, which is particularly important during charging of the galvanic cell, because when charging at an electrolyte temperature that exceeds the maximum permitted values, irreversible processes occur in the current conductors of the galvanic cell and impair the operating reliability of the galvanic cell, and consequently the service life thereof. Indirect cooling or heating of the electrolyte via the wall elements of the galvanic cell using the heat conducting units disposed outside of the galvanic cell results in a lower heat transmission coefficient, in particular if the positions of these heat conducting units is interfered with and the surfaces that come in contact with each other are unevenly lubricated with heat conducting agent, whereby the effectiveness of the heat conducting unit outside of this galvanic cell is diminished.

Preferably at least one current conductor of the at least one galvanic cell is designed as a heat pipe at least in some sections, wherein this section is provided to cool or heat the electrolyte. Preferably at least one first region of the section of the current conductor designed as a heat pipe is disposed inside the at least one galvanic cell, wherein this at least one first region preferably also interacts with the electrolyte of the at least one galvanic cell. It is further preferred for at least one second region of the section of the current conductor designed as a heat pipe to be disposed outside of the at least one galvanic cell, wherein this at least one second region is also provided for a second fluid to flow against and/or flow through at least in some regions. It is further preferred for this at least one second region to also be provided to be heated preferably by resistance heating.

The at least one heat conducting unit is preferably associated with at least one delivery unit. The at least one delivery unit is also delivers the at least one second fluid, wherein this fluid flow preferably flows against or through the at least one second region of the heat conducting unit, at least in some regions. The delivery unit is preferably associated with at least one heat exchanger unit, which is provided to control the at least one second fluid to a preferably preset temperature.

The at least one galvanic cell is preferably associated with at least one measuring unit that determines the temperature at a predefined site of the at least one galvanic cell. To this end, a plurality of measuring means for capturing temperatures at various positions of the at least one galvanic cell are preferably also connected to a measuring unit. This measuring unit is suited to record the signals of the measuring means at any time. For practical considerations and so as to reduce the data volume, the capturing is preferably carried out at a low frequency, the frequency preferably ranging between 1 Hz and 100 Hz. This is also dependent on the thermal capacities and thermal transmission coefficients that are involved.

The at least one galvanic cell is preferably associated with at least one control unit, which is also provided to control the at least one measuring unit and to evaluate the signals thereof. This is done based on predefined computing rules. These rules take different characteristic curves of the individual measuring means into account. The control unit is also suited to control delivery devices that are present. Depending on the operational state of the at least one galvanic cell, individual or several delivery devices are switched. The functions of this control unit can also be assumed by another controller or a battery management system.

According to the invention, preferably a separator is used that comprises a substance-permeable carrier, which is preferably partially permeable, which is to say substantially permeable with respect to at least one substance and substantially impermeable with respect to at least one other substance. The carrier is coated with an inorganic material on at least one side. The substance-permeable carrier used is preferably an inorganic material, which is preferably designed as a nonwoven fabric. The organic material, preferably a polymer, and still more preferably polyethylene terephthalate (PET), is coated with an inorganic ion-conducting material, which is preferably ion-conducting in a temperature range of −40° C. to 200° C. The inorganic ion-conducting material preferably comprises at least one compound of the group consisting of oxides, phosphates, sulfates, titanates, silicates, aluminosilicates having at least one of the elements Zr, Al, Li, with zirconium oxide being particularly preferred. The inorganic ion-conducting material preferably comprises particles having a largest diameter of less than 100 nm.

Preferably, each galvanic cell of the device according to the invention comprises at least one separator. Such a separator is sold, for example, under the trade name “Separion” by Evonik AG in Germany.

The at least one galvanic cell of the device according to the invention preferably has a substantially cuboid or prismatic design. Such substantially cuboid galvanic cells can be brought in contact with each other particularly well and can be accommodated in the interior space.

At least one first longitudinal extension 11 of the at least one galvanic cell (1) preferably ranges between 15 cm≦I1≦50 cm, more preferred between 20 cm≦I1≦30 cm, and still more preferred between 24 cm≦I1≦27 cm.

At least one second longitudinal extension 12 of the at least one galvanic cell (1) preferably ranges between 10 cm≦I2≦40 cm, more preferred between 15 cm≦I2≦25 cm, and still more preferred between 20 cm≦I2≦21 cm.

At least one third longitudinal extension 13 of the at least one galvanic cell (1) preferably ranges between 0.5 cm≦I3≦5 cm, more preferred between 1 cm≦I3≦2 cm, and still more preferred between 1.1 cm≦I3≦1.2 cm.

Further advantages, characteristics, and application options of the present invention will be apparent from the following description in connection with the figures. In the drawings:

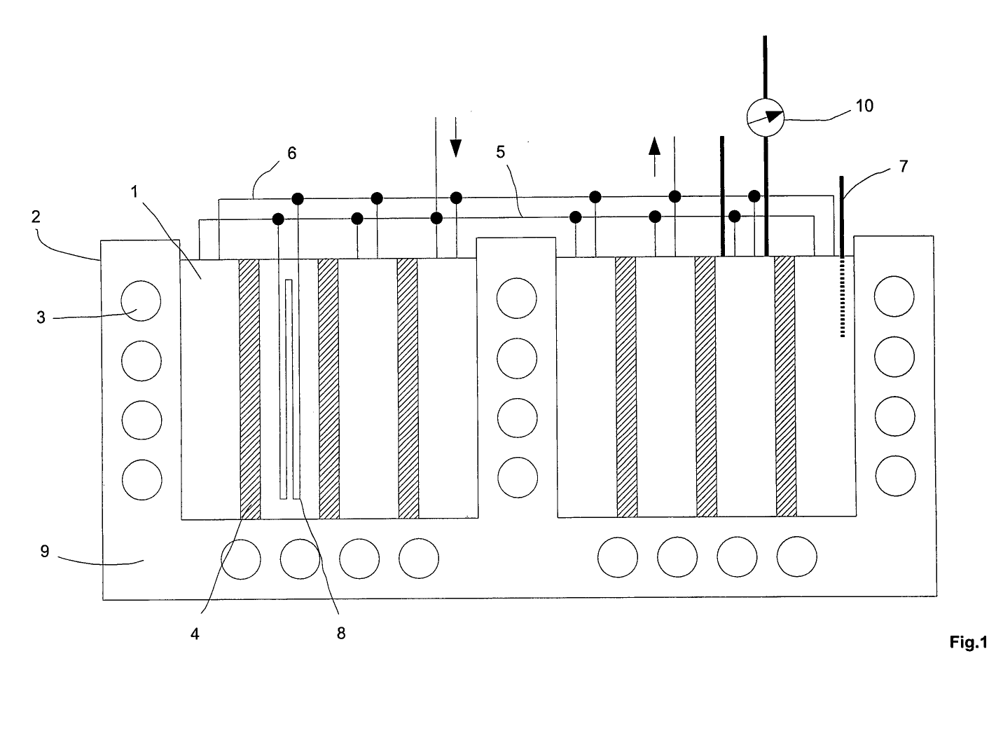

FIG. 1: shows a sectional view of a rechargeable battery according to the invention,

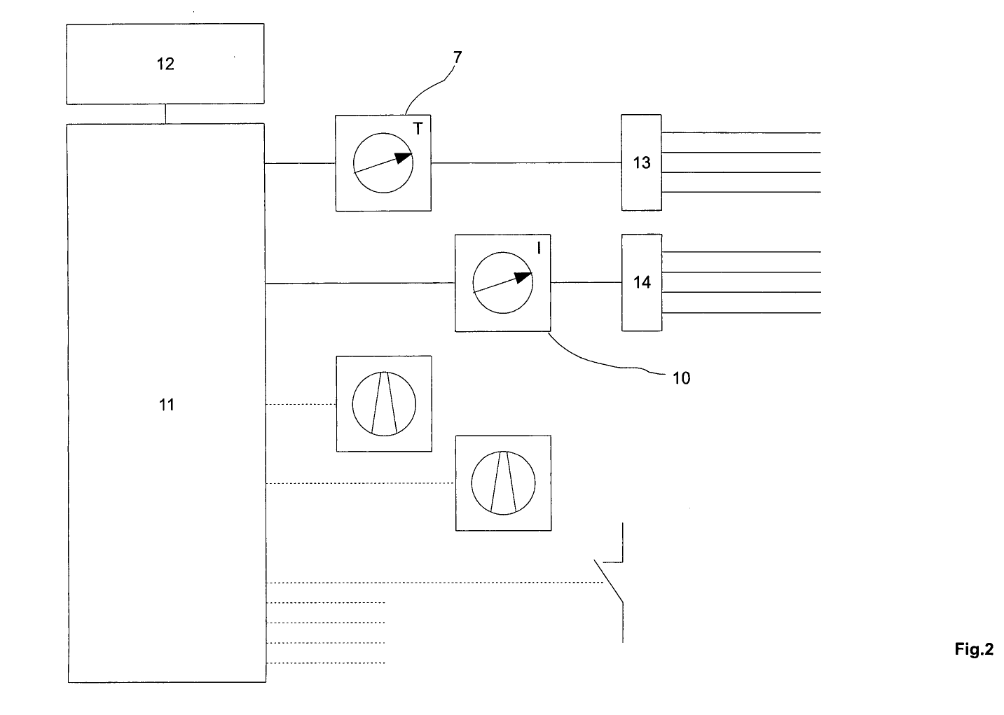

FIG. 2: shows an array of control and measuring units according to the invention,

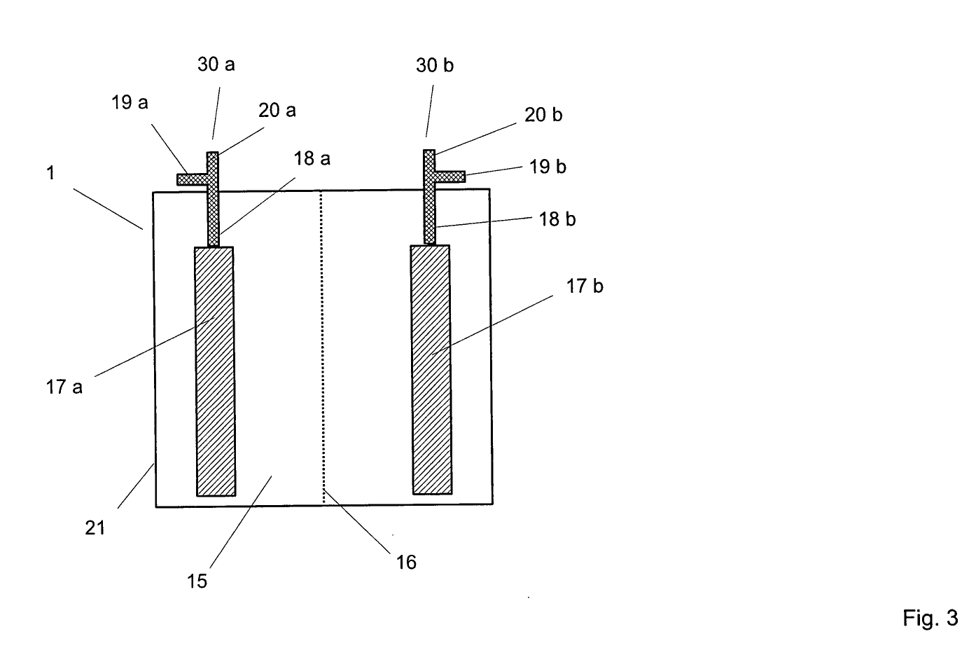

FIG. 3: shows a cross-section of a galvanic cell according to the invention.

FIG. 1 shows a device according to the invention for storing electric energy in a preferred embodiment. The illustration is not true to dimension. The rechargeable battery shown comprises two groups of 4 galvanic cells each. In order to increase the charge, the two groups are connected in parallel. Within a group, four galvanic cells 1 are connected in series. The electric interconnection, however, is not shown. The individual cell jackets, which are designed as gas-tight and welded films, are also not shown.

A heat conducting unit 8 is associated with each galvanic cell 1. In this example, the heat conducting unit 8 is designed as what is referred to as a microchannel cooler 8. A temperature-controlled second fluid flows through the channels of the microchannel cooler 8, wherein the geometry of the channel, the substance properties of the second fluid and the flow speed thereof are selected such that the Reynolds number or Nusselt number of the flow is as high as possible. The feed lines 5 and the line 6 are provided to supply the microchannel cooler. Depending on the temperatures of the galvanic cell 1 and the second fluid, heat is supplied to the galvanic cell 1, or withdrawn therefrom, using the microchannel cooler 8.

In another embodiment, which is not shown, the microchannel cooler is replaced by what is referred to as a heat pipe. This results in further changes to the design, without this embodiment being devoid of the characteristics of the claims.

According to FIG. 1, the galvanic cells 1 are received by a cell holder 2. The wall 9 of this holder is thin and produced from a curable synthetic material and it encloses the galvanic cells avoiding air inclusions. The interior space of the cell holder 2 comprises two cavities separated by a wall, each receiving 4 galvanic cells. The cell jackets, which are not shown, are enclosed by the wall 9 such that it is possible to transfer high heat flows between a galvanic cell 1 and the wall 9. Ducts 3 for a fourth fluid are configured in the wall 9 of the cell holder 2. These ducts are introduced in the wall 9 during the production of the cell holder 2. A fourth fluid, which can supply or remove heat, flows through these ducts 3. The units for delivering these fluids are switched on and off by a control unit 11, which is not shown.

By way of example, the figure shows only a first measuring unit 7 for capturing a temperature. This is a thermocouple 7, the contacts of which are connected to the control unit 11, which is not shown. Although this is not shown, each of these galvanic cells 1 comprises a dedicated thermocouple 7. In this embodiment of the rechargeable battery, each thermocouple 7 is polled at a frequency of 100 Hz. The device further comprises second measuring units 10. The figure shows an amperemeter 10, which measures the intensity of the electric current that is supplied to a galvanic cell 1 or withdrawn therefrom.

A thermally conductive foil 4 is disposed between the individual galvanic cells 1. This thermally conductive foil 4 is used to improve the thermal contact between the individual galvanic cells, also by enlarging the actual contact surface areas. Moreover, this thermally conductive foil 4 additionally exerts elastic restoring forces on the galvanic cells so as to prevent undesirable movements of the same.

When producing the cell holder 2 from a curable synthetic material using a mold, preferably excellent thermal contact is achieved between the wall 9 and a galvanic cell 1 that is in contact with this wall.

FIG. 1 does not show the adjacent or mutually interacting units for supplying the device. These include, for example, the coolant circuits that supply the microchannel coolers 8 and the ducts 3. The figure also does not show various attachments of the cell holder 2, which are required for the flawless function of the rechargeable battery.

FIG. 2 shows an array according to the invention comprising control and measuring units for controlling the temperature of the rechargeable battery. A control unit 11 is shown, which is associated with a memory unit 12. This memory unit 12 saves computing rules, captured and evaluated measurement values, and temperature specifications or target values. This memory unit 12 further contains specifications for the temperature control of the rechargeable battery. These specifications for temperature control are used by the control unit 11 to switch existing units on or off in an anticipatory manner. A first measuring unit 7 for capturing temperatures of connected galvanic cells is connected to the control unit 11. A change-over switch 13 is connected to this first measuring unit 7, and the various thermocouples are connected to the switch. Moreover, a second measuring unit 10 for capturing electric currents is connected to the control unit 11. A change-over switch 14 is connected to this second measuring unit 10, and the various amperemeters are connected to the switch. Moreover, a number of delivery units for fluids and control lines to various switches are connected to the control unit 11.

In this embodiment of the array of control and measuring units, the control unit 11 is able to carry out the temperature control of the rechargeable battery that is operated in an anticipatory manner. To this end, the functions of the control unit 11 can also be assumed by another controller that is present or a higher-level battery management system.

FIG. 3 shows a cross-section of a galvanic cell (1) of the device according to the invention, wherein this galvanic cell (1) is partially surrounded by a cell jacket (21). The illustration is not true to dimension. The interior space (15) enclosed by the cell jacket (21) accommodates 2 electrodes (17 a, 17 b), a separator (16) and an electrolyte, which is not shown. Moreover, the current conductors or heat conducting units are accommodated in some regions of the interior space (15). The current conductors and one heat conducting unit are in each case designed integrally as components (30 a, 30 b). The heat conducting unit is configured as a heat pipe. The respective first regions of the heat conducting units (18 a, 18 b) are configured in each case together with a first section of the current conductors as functional blocks for heat conduction and current conduction, wherein these regions are partially surrounded by the cell jacket (21). In addition, each of the first regions of the heat conducting units configured as heat pipes comprises an evaporation zone (18 a, 18 b). Outside of the cell jacket, each of the components (30 a, 30 b) comprises a substantially solid metal region (19 a, 19 b), wherein these regions do not contain fluid ducts and wherein these regions (19 a, 19 b) are preferably used for the electric contacting of the galvanic cell (1). Each of the second regions of the heat conducting units configured as heat pipes comprises a condensation region (20 a, 20 b) outside of the galvanic cell. This array of condensation and evaporation regions is provided to cool the galvanic cell (1), and in particular the electrodes (17 a, 17 b). Depending on the temperatures that prevail inside and outside of the galvanic cell (1), the evaporation region (18 a, 18 b) and the condensation region (20 a, 20 b) of a component (30 a, 30 b) may also be reversed. The condensation regions (20 a, 20 b) are then disposed inside the cell jacket and the evaporation regions (18 a, 18 b) outside of the cell jacket, wherein with this arrangement the galvanic cell (1) and notably the electrodes (17a, 17b) are heated when needed.

1. A device for storing electric energy, comprising at least one galvanic cell (1) surrounded at least partially by a cell jacket (21),
at least one heat conducting unit (8, 30 a, 30 b) being provided, which is operatively connected to the galvanic cell (1), this heat conducting unit (8) being suited to supply heat output to this cell or removing it from the same, wherein the at least one heat conducting unit (30a, 30b) is designed in some regions as a heat pipe comprising an evaporation zone (18 a, 18 b), is partially surrounded by the cell jacket (21), and outside of the cell jacket comprises a substantially solid metal region (19 a, 19 b), wherein this region does not contain a fluid duct and is used for the electric contacting of the galvanic cell (1).

2. The device according to claim 1, wherein
at least one cell holder (2) is provided, which at least partially encloses an interior space with a wall (9),
wherein this interior space is suited to receive the at least one galvanic cell (1), and wherein this cell jacket is operatively connected at least partially to the wall (9),
wherein heat conducting means (4) are disposed between the cell jacket and the wall (9) of the cell holder (2) and/or a further cell jacket.

3. The device according to claim 2,
wherein at least one first measuring unit (7) is provided, which is suited to capture a temperature at a predefined position of the galvanic cell (1).

4. The device according to claim 3,
wherein at least one control unit (11) is provided, which is at least suited to evaluate a signal of the existing first measuring units (7) or to control the existing heat conducting units (8).

5. The device according to claim 4, wherein
at least one second measuring unit (10) is provided, which is suited to capture the current intensity of the electric current into or out of the galvanic cell (1) and to transmit the current intensity to the control unit (11),
or the device comprises a memory unit (12), which is associated with the control unit (11), wherein the memory unit (12) is suited to save at least data or computing rules.

6. The device according to claim 5, wherein
the at least one galvanic cell (1) has a prismatic design or in the form of a heat conducting unit (8) comprises at least one substantially plate-shaped current conductor having at least one first region disposed inside the cell and a second region disposed outside of the cell, the second region being at least as wide as the first region,
wherein the second region being preferably operatively connected to a heat sink comprising at least copper or aluminum,
and a first fluid at least partially flows against the second region or the heat sink.

7. The device according to claim 6, wherein
a heat conducting means (4) is designed to have thin walls or be electrically insulating.

8. The device according to claim 7, wherein
a heat conducting means (4) is in planar contact with adjacent components or is bonded to these adjacent components.

9. The device according to claim 8, wherein
the at least one galvanic cell (1) comprises at least one heat conducting unit (8),
the heat conducting unit (8) comprises at least one first fluid duct having a third region inside the cell or in operative connection to the cell or a fourth region outside of the cell (1) and a second fluid contained in the first fluid duct,
the second fluid flows inside the first fluid duct or is subjected to phase transitions,
and a third fluid flows at least partially against the fourth region or the fourth region is operatively connected to a heat sink.

10. The device according to claim 9, wherein
the device further comprises a container, which is filled at least partially with a third substance,
the third substance undergoes phase transitions at predetermined temperatures, wherein the third substance is preferably not electrically conductive or the third substance still more preferably comprises CO2,
and the container comprises at least one closing element, which is suited to be opened at least partially by the control unit.

11. The device according to claim 10, wherein
the wall (9) of the cell holder (2) comprises at least one curable first substance, preferably a synthetic material, and embedded particles, the thermal conductivity of these particles being at least as high as the thermal conductivity of the curable first substance,
or the galvanic cells (1) are at least partially enclosed by the wall (9),
or the wall (9) comprises at least one second fluid duct (3) through which a fourth fluid flows, or the wall comprises a connecting surface area for a thermal operative connection to a cooled and/or heated surface area, for example a surface area of an evaporator intended for this purpose,
or the wall (9) comprises a second substance, this substance being suited to undergo phase transitions during the operation of the device or at a predefined temperature.

12. The device according to claim 11, wherein
the at least one galvanic cell (1) comprises lithium or lithium ions, or the electrolyte comprises lithium ions.

13. The method for operating the device according to claim 12, wherein
the first measuring unit (7) at least intermittently captures the temperature at a predefined site of a galvanic cell or the second measuring unit (10) captures the intensity of the electric current into or out of a galvanic cell (1),
the control unit (11) determines the temperature difference based on the captured temperature and a temperature predefined for this purpose,
and the control unit (11) switches a heat conducting unit (8) or a delivery unit for a fluid on or off depending on the measured temperature, the detected temperature difference or a captured current intensity.

14. A method for creating a cell holder (2) for the device according to claim 12 using a mold and at least one curable first substance, comprising the following steps:
a) arranging the galvanic cells (1) in the mold, wherein gaps are filled with heat conducting means (4) and the cells are subsequently pressed against one another,
b) potting cavities that are provided with the curable first substance,
c) curing the curable first substance.

15. The device according to claim 1, wherein
the at least one heat conducting unit (30 a) is provided at least regionally for the contact with the at least one galvanic cell (1), and in particular for the contact with the electrode stack (17 a, 17 b) of the at least one galvanic cell.

16. The device according to claim 15, wherein
the at least one heat conducting unit (30 a) comprises at least one fluid duct, which is provided in particular for a fluid to flow through.

17. The device according to claim 16, wherein
the fluid is provided to undergo at least one phase transition, the temperature of the at least one phase transition of the fluid being adapted to the operating temperature of the at least one galvanic cell (1).

18. The device according to claim 17, wherein
the at least one heat conducting unit (30 a) is guided at least partially out of the cell jacket (21) of the at least one galvanic cell (1).

19. The device according to claim 18, wherein
the at least one heat conducting unit (30 a) comprises at least one first region (18 a) and a second region (20 a), the first region (18 a) being disposed inside the cell jacket (21) and the second region being disposed outside of the cell jacket (21).

20. The device according to claim 19, characterized in that wherein
the electrode stack (17 a, 17 b) comprises at least one current conductor (30 a) and the at least one heat conducting unit (30 a) is provided at least regionally for the contact with the at least one current conductor (30 a).

21. The device according to claim 20, wherein
the first region of the heat conducting unit (18 a) is provided for the heat exchange with the electrode stack (17 a, 17 b) of the at least one galvanic cell, and the second region of the heat conducting unit (20 a) is provided for a second fluid to flow against or through it.

22. The device according to claim 21, wherein
the second region of the heat conducting unit (20 a) is provided for the heat-conducting contact with a heat exchanger unit.

23. The device according to claim 22, wherein
the at least one heat conducting unit (30 a) is designed integral with the at least one current conductor (30 a), the heat conducting unit (30 a) extending at least partially over the at least one current conductor (30a).

24. The device according to claim 23, wherein
the at least one fluid duct is closed.

25. The device according to claim 24, wherein
at least one delivery unit is associated with the at least one heat conducting unit (30 a), in particular with the at least one fluid duct.

26. The device according to claim 25, wherein
the at least one galvanic cell (1) is associated with at least one measuring unit, in particular a temperature measuring unit.

27. The device according to claim 26, wherein
the at least one galvanic cell (1) is associated with at least one control unit, which is also provided to control the at least one measuring unit.

28.-33. (canceled)
